(19) United States
(12) Patent Application Publication
(10) Pub. No.: US 2002/0092798 A1
(43) Pub. Date: Jul. 18, 2002

(54) Method and apparatus for reclaiming concrete

(76) Inventors: Michael Robert Dehart, Seabrook, TX (US); Lee Roy Jackson, Arcola, TX (US)

Correspondence Address: ANASTASSIOS TRIANTAPHYLLIS, P.O. Box 27629, Houston, TX, 77227, US

(21) Appl. No.: 10/053,720

(22) Filed: Jan. 17, 2002

Related U.S. Application Data
(60) Provisional application No. 60/262,546, filed on Jan. 16, 2001.

(51) Int. Cl. B03B 7/00; B07B 1/00

(52) U.S. Cl. 209/17; 209/244; 209/273

(57) ABSTRACT

An apparatus and method for reclaiming uncured concrete are disclosed. The apparatus includes a hopper with water inlet for introducing water to the hopper. The outlet of the hopper is connected to a separator that is suitably connected to the hopper to receive material therefrom. A screen is positioned in the separator to separate material flowing therethrough. The separator has two outlets for removing material from the separator.

### RELATED PRIORITY DATE APPLICATION

This application claims the benefit under 35 U.S.C. 119(e) of the U.S. provisional application No. 60/262546 filed on Jan. 17, 2001.

### TECHNICAL FIELD OF THE INVENTION

The present invention relates to solid/liquid separation, and, more particularly, to an apparatus and a method for reclaiming uncured concrete. Still more particularly, the present invention discloses a method and an apparatus for separating cement slurry, sand, and gravel from mixed concrete for future use.

### BACKGROUND OF THE INVENTION

The wide use of concrete for the construction of roads, buildings and the like is well known. In most building operations utilizing concrete, there is always left over a significant amount of unused, uncured concrete. That concrete is not easily disposable and presents a serious environmental problem. Furthermore, the unused concrete is an economic waste. In order to solve the disposal problem and to reduce the economic waste, methods have been developed to reclaim the concrete for further usage in the preparation of new concrete. Those methods utilize pits which are dug in the ground to recover the concrete material through gravity separation. One difficulty with the use of those pits is that they are fixed and cannot be transported to different locations as the need arises. Still, another disadvantage is the water used in those methods presented disposal problems.

According to the present, an apparatus and a method for reclaiming unused, uncured concrete utilizing portable, above ground equipment that are capable of recovering rock, sand and light cement material for future use. The water being used to assist in the separation is recycled and the need for disposing that water in large quantities is eliminated.

These and other advantages of the present invention will become apparent from the following description and drawings.

### SUMMARY OF THE INVENTION

A concrete reclaimer and a method for separating cement slurry, sand, and gravel from mixed concrete for future use are disclosed. The concrete reclaimer includes a hopper, a pump, a separator, a sand tank and four water holding tanks, connected in series. The pump is mounted at the bottom of the hopper for pumping material from the hopper to the separator via a hose which is removably connected to the pump. The hopper and the separator are connected to a water distribution manifold by hoses for receiving water recirculated from the four water holding tanks.

The hopper includes a hopper holding tank with an upper edge at a height which is suitable for receiving discharge of waste, uncured concrete from a concrete mixer truck. Several manifolds provide water to the interior portion of the holding tank, the hopper lower water supply and pump cooling nozzles.

The separator is supported above the sand tank by four adjustable legs and has a bottom discharge opening for flowing material from the separator to the sand tank. A chute is attached to the separator for removing material therefrom. A rotatable screen wheel is mounted on the interior of the separator and is driven by a drive mechanism mounted on the outside wall of the separator.

The sand tank is followed by four tanks connected in series with each tank receiving overflow material from the previous tank. Discharge assemblies at the bottoms of each of the four tanks are connected to a hose connected to a water pump that recirculates water and solid material.

In operation, a concrete mixer truck carrying unused, uncured concrete positions its discharge chute over the hopper. The water recirculation pump is activated to begin pumping water to the hopper and the separator. The water is injected through two separate inlets into the upper and lower portions of the hopper. The concrete from the truck and any washed material from the truck concrete container is then discharged into the hopper where is it contacted by the water to create a diluted concrete slurry which is pumped by the pump to the upper portion of the separator. Therein, the water is sprayed through sprayers. The slurry flows by gravity inside the separator. When the slurry reaches the rotating screen wheel rock material of larger diameter is screened out from the slurry and is centrifugally directed to a discharge outlet from the separator. The remaining material comprising cement, sand and water slurry flows by gravity to the bottom of the separator and exits therefrom through its open end to fall by gravity to the sand tank where most of the sand settles. The effluent from the sand tank flows to the fist water holding tank. Overflow from the first tank flows to the second tank, overflow from the second tank flows to the third tank and overflow from the third tank flows to the fourth tank. Water is continuously removed from the bottom of the four tanks to the water pump that recirculates the water. In the process described, the rock is separated from the concrete slurry in the separator, the sand is separated from the water/cement slurry in the sand tank and cement light material is separated from the water in the four water tanks. The separated rock, sand and light cement material are thus recovered for future use.

### BRIEF DESCRIPTION OF THE DRAWINGS

For a detailed description of the preferred embodiments of the invention, reference will now be made to the accompanying drawings wherein:

Figure 1A is schematic top view of the preferred embodiment of the apparatus of the present invention;

Figure 1B is a schematic rear view of the embodiment of FIG. 1A.;

FIG. 2A is a schematic top view of a section of the apparatus of FIG. 1A;

FIG. 2B is a schematic side view of the apparatus of FIG. 2A;

FIG. 2C is a schematic bottom view of the apparatus of FIG. 2A;

FIG. 3 is a partly elevational, partly schematic view of a section of the apparatus of FIG. 2A;

FIG. 4 is a partly elevational, partly schematic view of another section of the apparatus of FIG. 2A;

FIG. 5 is a partly elevational, partly schematic view of another section of the apparatus of FIG. 2A;

FIG. 6 is a partly elevational, partly schematic view of another section of the apparatus of FIG. 2A;

FIG. 7 is a partly elevational, partly schematic view of another section of the apparatus of FIG. 2A;

FIG. 8 is a schematic side view of another section of the apparatus of FIG. 1A;

FIG. 9 is a schematic side view of a section of the apparatus of FIG. 8;

FIG. 10 is a schematic side view of another section of the apparatus of FIG. 1A;

FIG. 11A is a schematic top view of a section of the apparatus of FIG. 8;

FIG. 11B is schematic side view of the apparatus of FIG. 11A;

FIG. 12A is a schematic front view of a section of the apparatus of FIG. 8;

FIG. 12B is schematic side view of the apparatus of FIG. 12A;

FIG. 13A is a schematic front view of a section of the apparatus of FIG. 8;

FIG. 13B is schematic top view of the apparatus of FIG. 13A;

FIG. 14A is a schematic top view of a section of the apparatus of FIG. 8;

FIG. 14B is a schematic side view of the apparatus of FIG. 14A;

FIG. 14C is a schematic, perspective, side view of the apparatus of FIG. 14A;

FIG. 15A is a schematic front view of a section of the apparatus of FIG. 8;

FIG. 15B is a schematic back view of the apparatus of FIG. 15A;

FIG. 16A is a schematic, perspective side view of a section of the apparatus of FIG. 8;

FIG. 16B is a schematic bottom view of the apparatus of FIG. 16A;

FIG. 17 is an elevational view of a section of the apparatus of FIG. 1A;

FIG. 18 is an elevational view of a section of the apparatus of FIG. 1A;

FIG. 19A is an elevational view of a section of the apparatus of FIG. 1A;

FIG. 19B is a front elevational view of the apparatus of FIG. 19A;

FIG. 20A is a schematic side view of an alternative embodiment of a hopper to be used in the apparatus of the present invention;

FIG. 20B is schematic opposite side view of the apparatus of FIG. 20A;

FIG. 20C is a schematic front view of the apparatus of FIG. 20A;

FIG. 20D is a schematic rear view of the apparatus of FIG. 20A;

FIG. 20E is a schematic top view of the apparatus of FIG. 20A; and

FIG. 20F is a schematic bottom view of the apparatus of FIG. 20B;

### DESCRIPTION OF THE PREFERRED EMBODIMENT

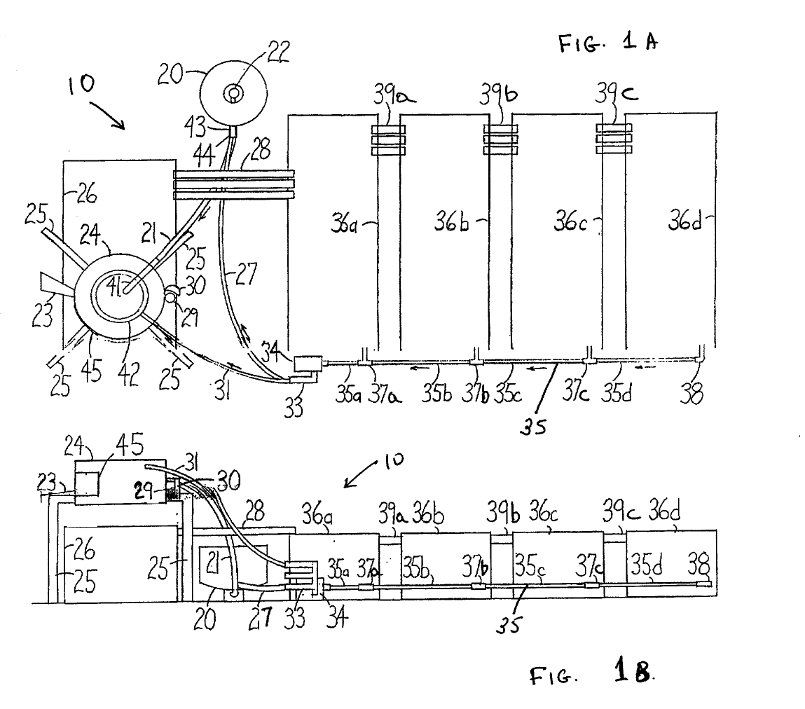

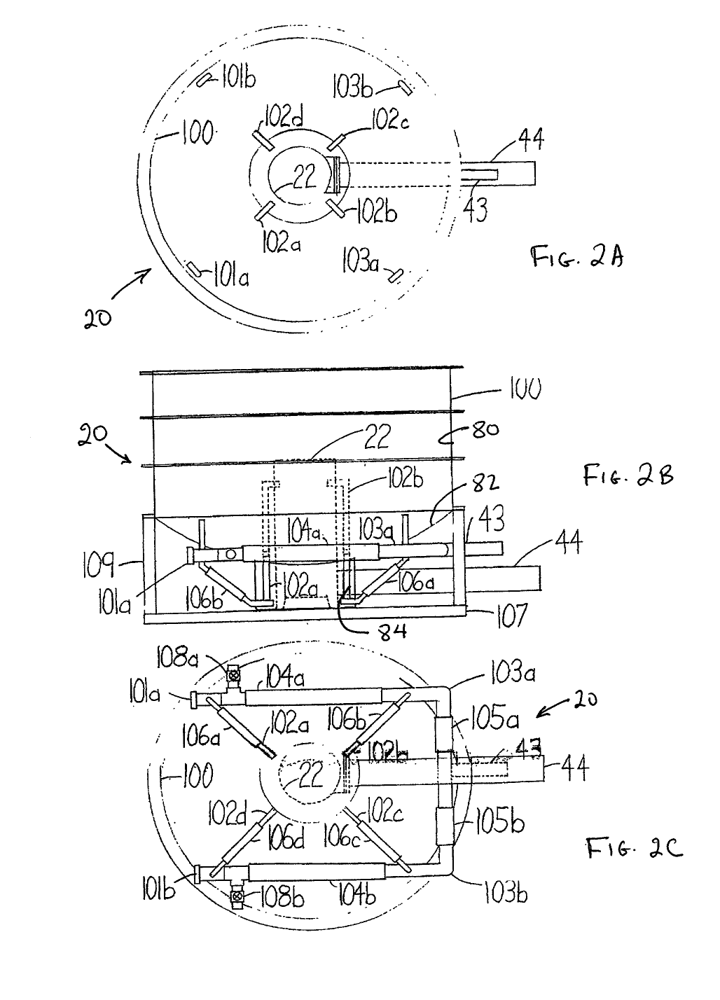

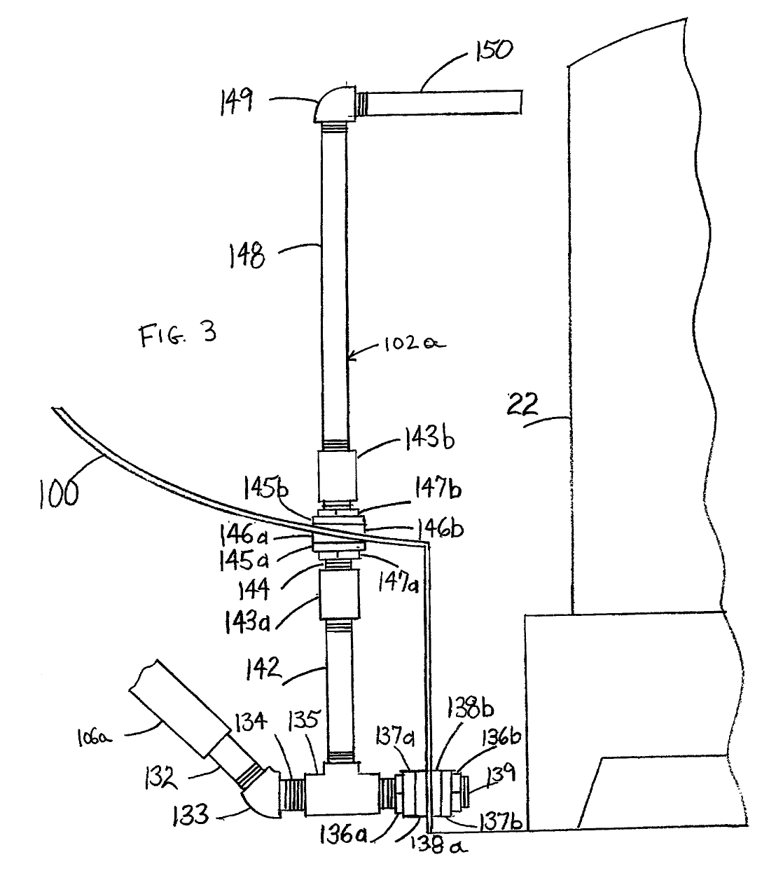

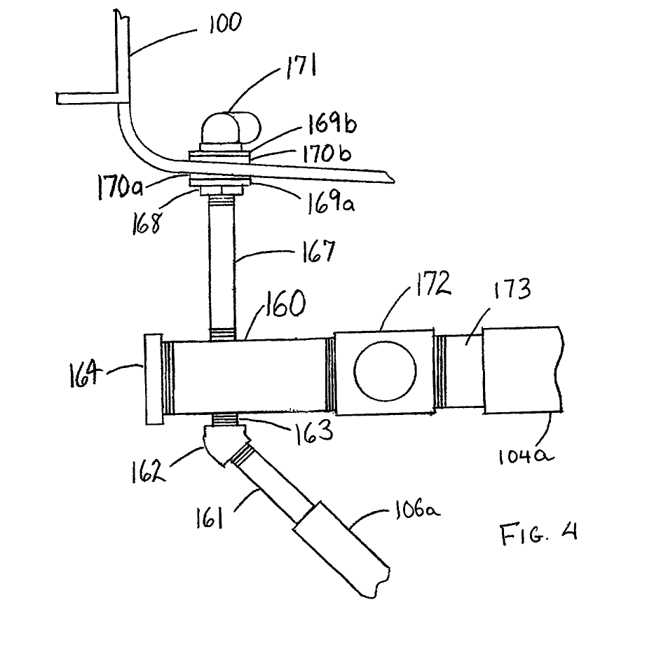

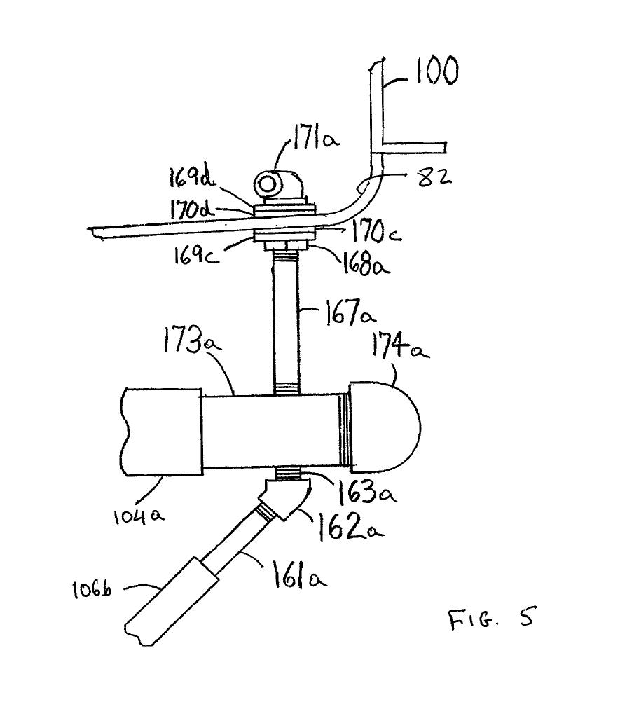

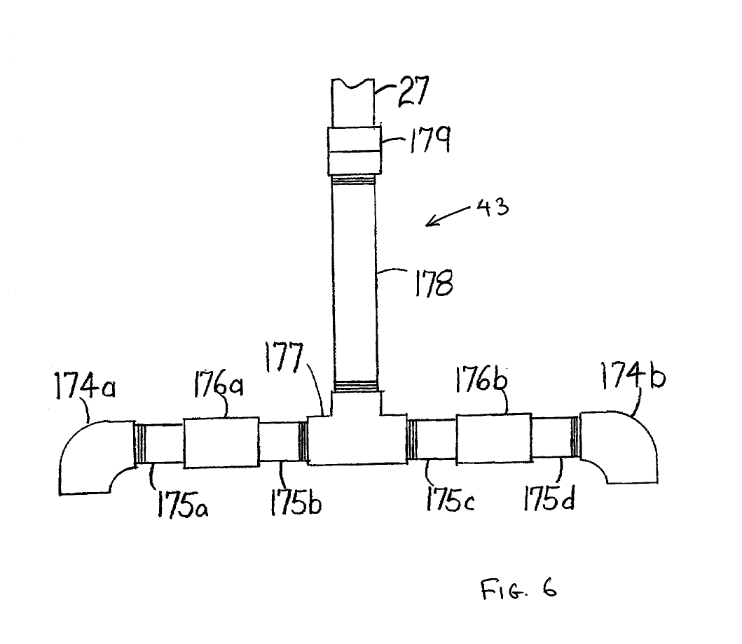

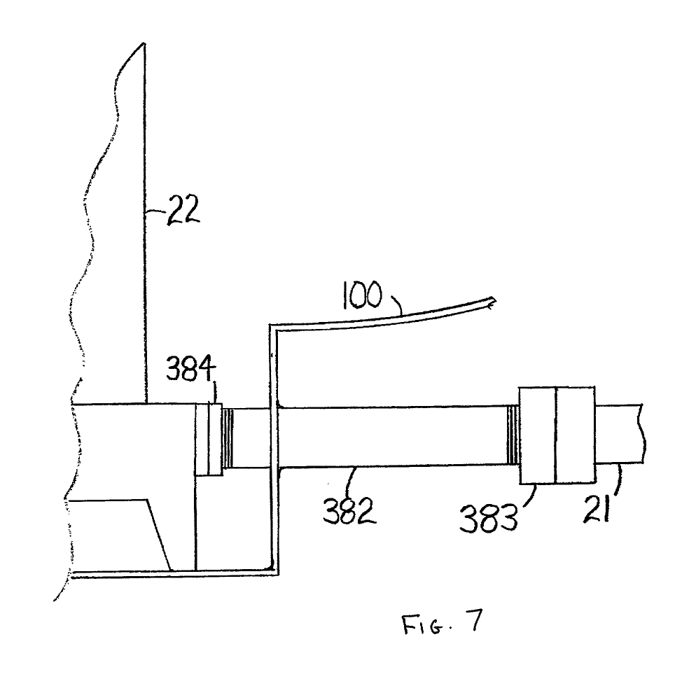

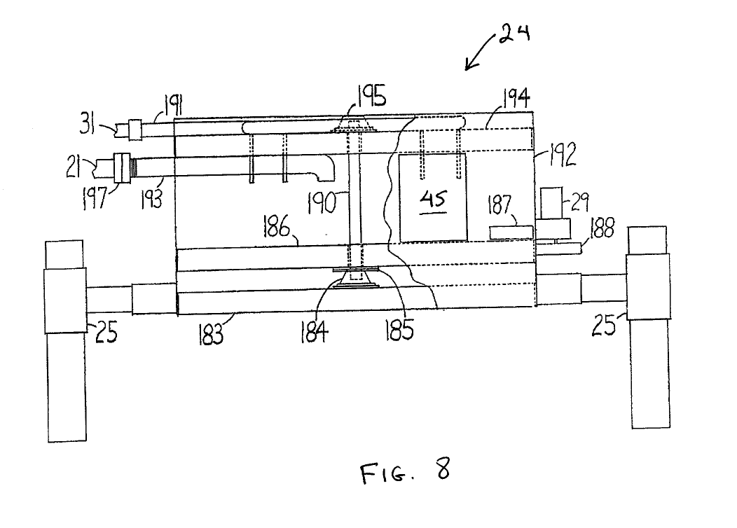

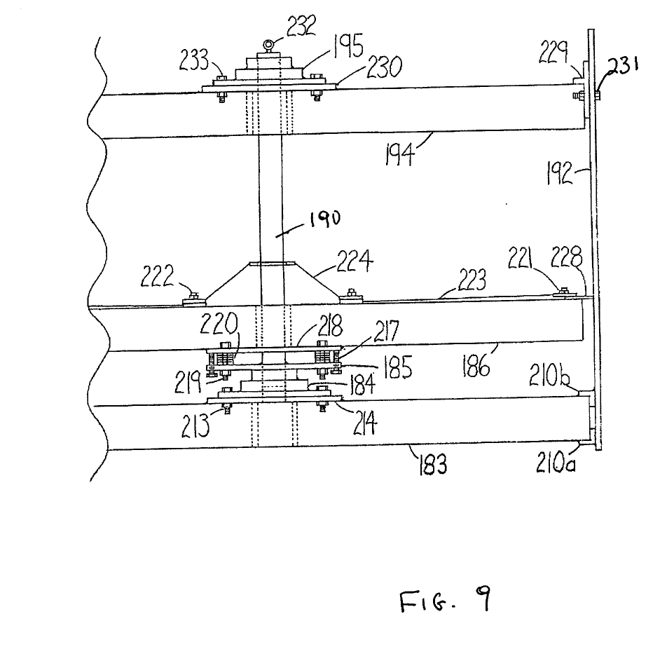

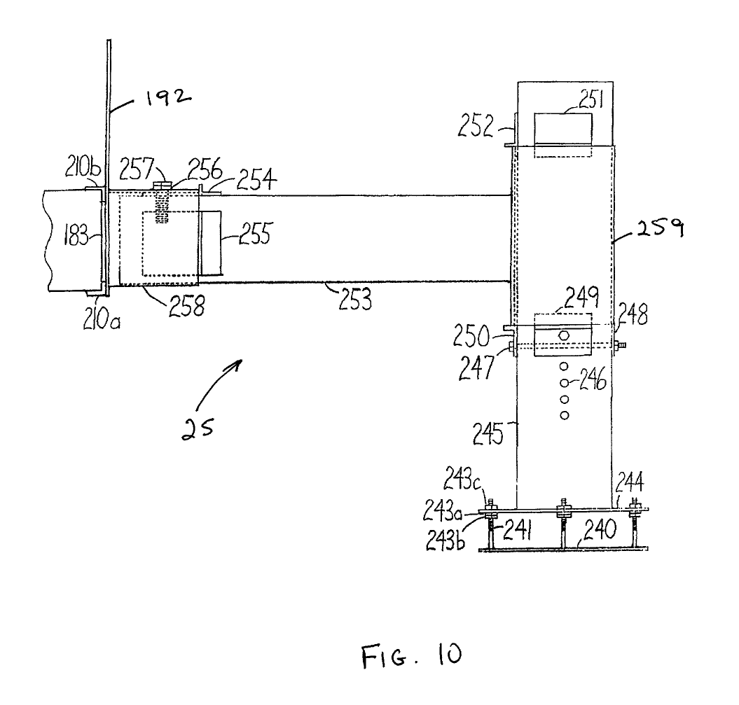

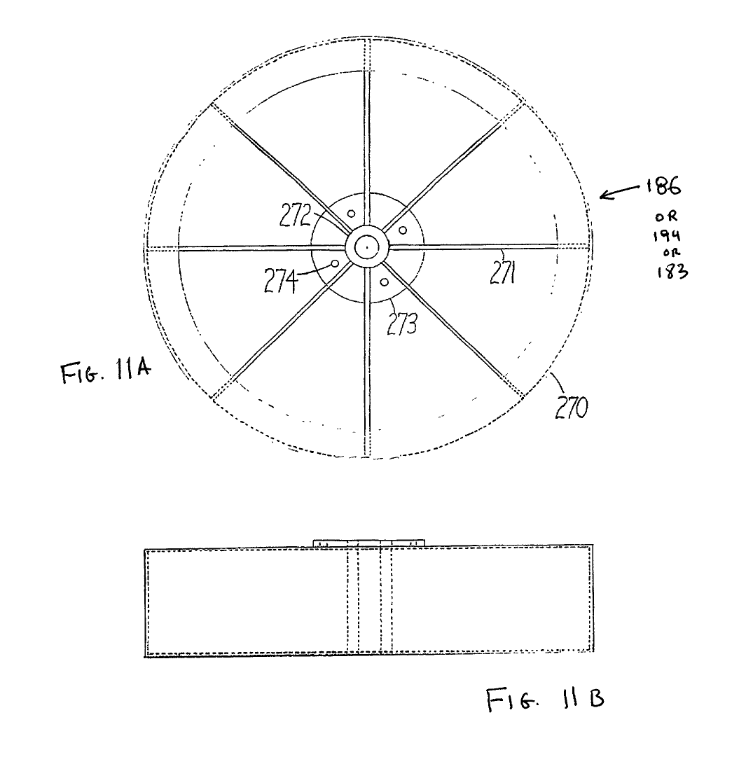

According to the present invention, an apparatus and a method are disclosed for separating cement slurry, sand, and gravel from mixed concrete for future use. Referring now to FIGS. 1A and 1B, there is shown a concrete reclaimer 10 in accordance with the present invention. Concrete reclaimer 10 includes a hopper 20, a pump 22, a separator 24, a sand tank 26 and water holding tanks 36a, 36b, 36c and 36d, connected in series.

Pump 22 is mounted at the bottom of hopper 20 for pumping material from hopper 20 to separator 24 via a hose 21 which is removably connected to pump 22 by quick connect/disconnect couplings. Pump 22 is attached to discharge pump connection 44. In a typical application, discharge pump 22 is rated at ten horsepower with a four inch discharge port and has the ability to pass three and one half inch solids and pump water at six hundred fifty gallons per minute at fifteen feet of head.

Hopper 20 and separator 24 are connected to a water distribution manifold 33 by a hose 27 and a hose 31, respectively, fitted with quick connect/disconnect couplings for receiving water recirculated from tanks 36a, 36b, 36c and 36d, as hereinafter described. Supply tee 43 connects hose 27 to hopper 20.

Separator 24 has a bottom discharge opening for flowing material from the bottom of separator 24 to tank 26 below. Separator is supported above tank 26 by four adjustable leg assemblies 25. A chute 23 is attached to separator 24 for removing material therefrom. A hatch 45 on separator 24 provides access to the interior of separator 24. A drive mechanism 29 is mounted on the outside wall of separator 24. Drive mechanism 29 is covered by cover 30.

Three pipes 28 connect tank 26 to tank 36a for flowing overflow material from tank 26 to tank 36a. Three pipes 39a connect tank 36a to tank 36b for flowing overflow material from tank 36a to tank 36b; three pipes 39b connect tank 36b to tank 36c for flowing overflow material from tank 36b to tank 36c; and three pipes 39c connect tank 36c to tank 36d for flowing overflow material from tank 36c to tank 36i. The inlets of pipes 39a, 39b and 39c are mounted about one foot bellow the mouths of tanks 36a, 36b and 36c, respectively, to allow for the collection of twelve inches of rain in case of a heavy rainfall.

Discharge assemblies 37a, 37b, 37c and 38 at the bottoms of tanks 36a, 36b, 36c and 36d, respectively, are connected to hose 35 comprised of hose portions 35a, 35b, 35c and 35d for flowing material by gravity from tanks 36a, 36b, 36c and 36d to hose 35. Hose portion 35a is connected to a pump 34 that discharges material to manifold 33 which is connected to hoses 27 and 31 and a utility hose (not shown). Pump 34 is rated at five horsepower with a three inch inlet and a three inch discharge and has the ability to pass 3/8 inch solids and pump water at four hundred gallons per minute at ten feet of head.

Referring now to FIGS. 2A, 2B and 2C, hopper 20 includes a hopper holding tank 100 having an upper cylindrical portion 80, a bottom dish 82 and a lower reduced diameter cylindrical portion 84, all seam welded together. Upper cylindrical portion 80 is preferably formed by welding in series a rolled channel, a rolled flat bar and another rolled channel. The upper edge of holding tank 100 is at a height which is suitable for receiving discharge of waste, uncured concrete from a concrete mixer truck.

Forward water manifolds 101a and 101b and rear water manifolds 103a and 103b provide water to the interior portion of holding tank 100. They also provide water to the hopper lower water supply and pump cooling nozzles 102a, 102b, 102c and 102d. Forward water manifolds 101a and 101b include ports with valves 108a and 108b, respectively, to supply water to mixer trucks for mixer drum wash out and for filling water tanks. Forward water manifold 101a is connected to rear water manifold 103a via a hose 104a and manifold 101b is connected to rear water manifold 103b by a hose 104b. Rear water supply manifolds 103a and 103b are connected to a supply tee 43 using hoses 105a and 105b, respectively. Hopper lower water supply and pump cooling nozzle 102a is connected to forward water manifold 101a via a hose 106a, nozzle 102b is connected to manifold 103a via a hose 106b, nozzle 102c is connected to manifold 103b via a hose 106c and nozzle 102d is connected to manifold 101b via a hose 106d. Hopper lower water supply and pump cooling nozzles 102a, 102b, 102c and 102d provide water to lower portion of hopper holding tank 100 and cooling water for discharge pump 22. Forward water manifolds 101a and 101b, rear water manifolds 103a and 103b, hopper lower water supply and pump cooling nozzles 102a, 102b, 102c and 102d, and water supply tee 43 are all assembled using standard plumbing components. Water supply tee 43 is connected to a pump (not shown) supplying concrete waste water under pressure to hopper 20 at 15 to 20 PSI and at a volume of 250 to 300 gallons per minute.

The threaded end of a discharge pump connection 44 is inserted through a port (not shown) in the lower part of hopper holding tank 100. A flange (not shown) is threaded on to discharge pump connection 44. The flange is bolted to the discharge port of the hopper discharge pump. Discharge pump connection 44 is seam welded into the port in the lower part of hopper holding tank 100.

Hopper holding tank 100 is supported in an upright, stable position through the use of a plurality of hopper support legs 109 welded to the underside flange of the lowest rolled channel comprising the body of hopper holding tank 100 and welded to the inside of a hopper rolled base angle 107.

Referring now to FIG. 3, there are shown the details of hopper lower water supply and pump cooling nozzle 102a. Hose 106a connects hopper lower water supply and pump cooling nozzle 102a to forward water manifold 101a (not shown). Hose 106a is fitted onto a nipple 132 threaded on one side which in turn is connected to a threaded forty five degree elbow 133. By means of a threaded nipple 134, elbow 133 is connected to a threaded tee 135. Threaded tee 135 is fitted with a threaded nipple 139 and a threaded nipple 142. Threaded nipple 139 is inserted through a port (not shown) at the bottom of hopper holding tank 100. The port is sealed by pipe nuts 136a and 136b, steel washers 137a and 137b, and rubber washers 138a and 138b installed on threaded nipple 139 on both sides of the wall of hopper holding tank 100.

Threaded nipple 142 is joined to a threaded nipple 144 by a threaded coupling 143a. Threaded nipple 144 is inserted through a port (not shown) located at the bottom of the dish section of hopper holding tank 100. The port is sealed by pipe nuts 147a and 147b, steel washers 145a and 145b, and rubber washers 146a and 146b installed on threaded nipple 144 on both sides of the wall of hopper holding tank 100. Threaded nipple 144 is attached to a threaded nipple 148 via a coupling 143b and threaded nipple 148 is attached to threaded ninety degree elbow 149. Elbow 149 is threadingly connected an outlet 150. Cooling water is discharged from outlet 150 onto discharge pump 22. Similar connections are made to nozzles 102b, 102c and 102d.

FIG. 4 depicts the details of forward water manifold 101a. Hose 106a is fitted with a nipple 161 threaded on one side only. The threaded end of nipple 161 is installed in a forty five degree elbow 162 containing a threaded nipple 163 fitted into a threaded port (not shown) in the bottom of a pipe 160. Pipe 160 is connected to a utility hose threaded tee and valve assembly 172 to which hose 104a connecting to the rear water supply manifold (not shown) is attached by a threaded nipple (one side only) 173. The threaded end of pipe 160 is fitted with a threaded cap 164. The top threaded port (not shown) in pipe 160 is fitted with a threaded nipple 167 which extends through a port (not shown) located on the top part of bottom dish 82 of hopper holding tank 100. The port is sealed by a pipe nut 168, steel washers 169a and 169b and rubber washers 170a and 170b installed on threaded nipple 167 on both sides of the wall of bottom dish 82 of hopper holding tank 100 and a threaded ninety degree elbow 171. A similar connection is made in manifold 101b.

FIG. 5 shows the details of rear water manifold 103a. Similar details apply to rear water manifold 103b. Hose 106b to hopper lower water supply and pump cooling nozzle 102b (not shown) is fitted with a nipple 161a threaded on one side only. The threaded end of nipple 161a is installed in a forty five degree elbow 162a containing a threaded nipple 163a fitted into a threaded port (not shown) in the bottom of a pipe 173a. A hose 104a is attached to pipe 173a. A threaded ninety degree elbow 174a with a nipple threaded on one side (not shown) is attached to the other end of pipe 173a. The top threaded port (not shown) in pipe 173a is fitted with threaded nipple 167a which extends through a port (not shown) located on the top part of bottom dish 82 of hopper holding tank 100. The port is sealed by a pipe nut 168a, steel washers 169a and 169b and rubber washers 170a and 170b installed on threaded nipple 167a on both sides of the wall of hopper holding tank 100 and a threaded ninety degree elbow 171a.

Discharge hopper water supply tee 43 is detailed in FIG. 6. Discharge hopper water supply hose 27 is connected to a threaded nipple 178 by a quick connect/disconnect coupling 179. At the other end of threaded nipple 178 is installed a threaded tee 177. Nipples 175a and 175d, threaded on one side only, are installed in each end of threaded ninety degree elbows 174a and 174b, respectively. Nipples 175b and 175c, threaded on one side only, are installed in threaded tee 177. Threaded nipples 175a and 175b are connected together by a hose 176a. Threaded nipples 175c and 175d are connected together by a hose 176b. Elbow 174a is connected to rear water manifold 103a as shown in FIG. 5. Elbow 174b is connected to rear water manifold 103b (not shown).

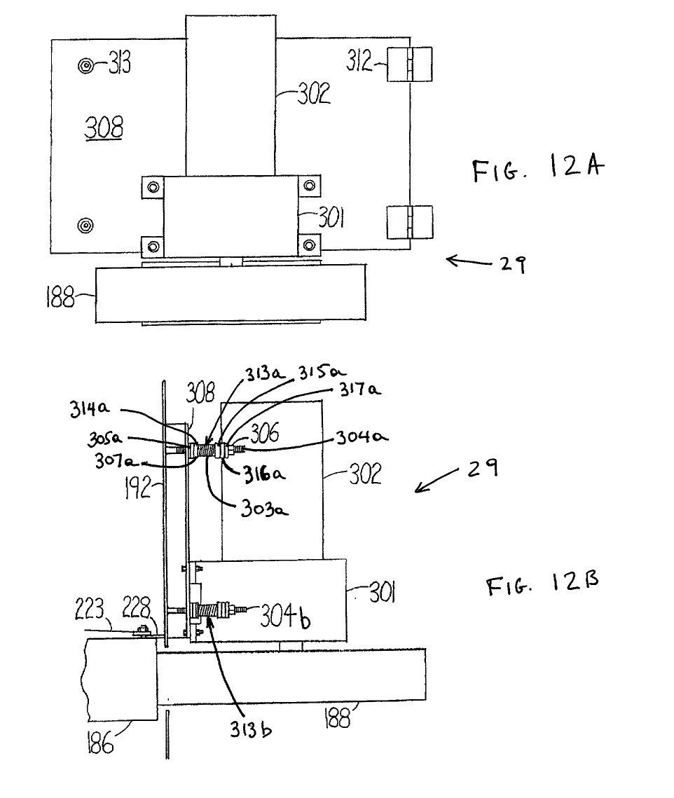

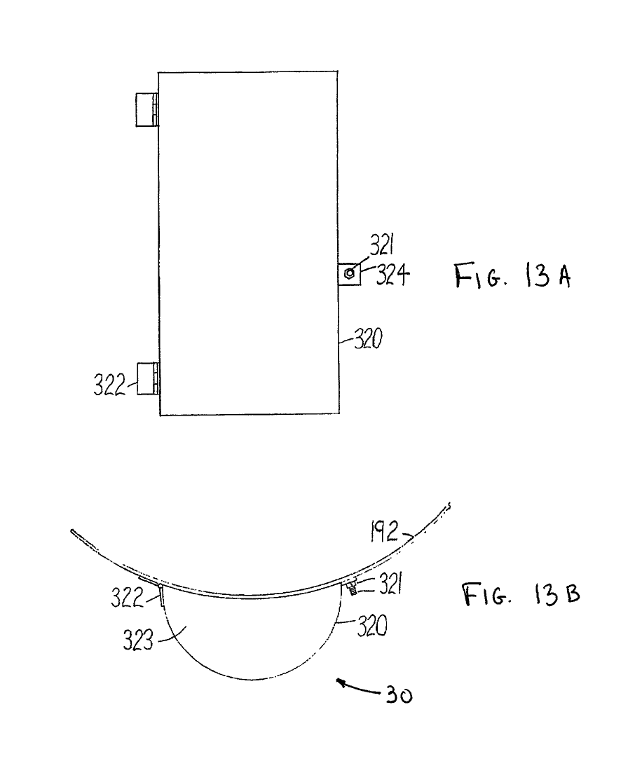

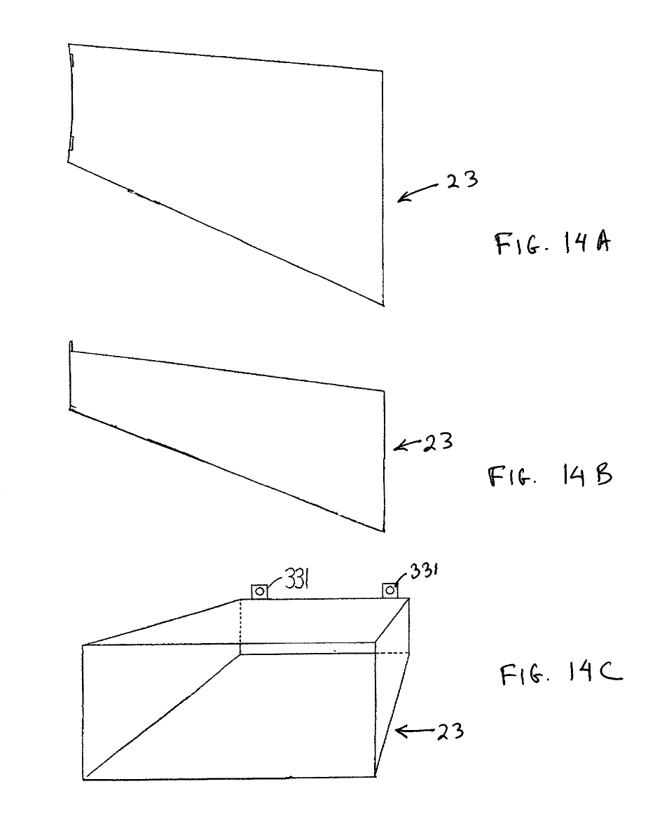

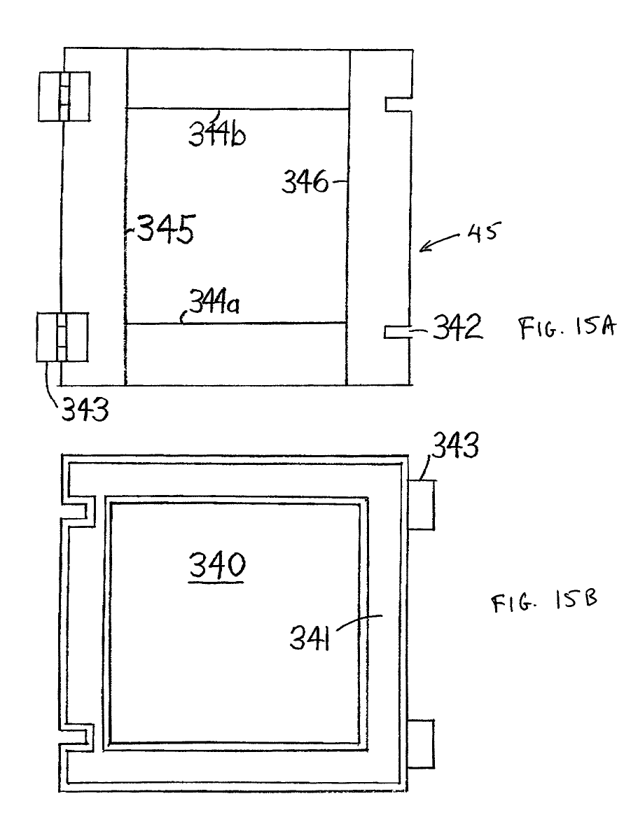

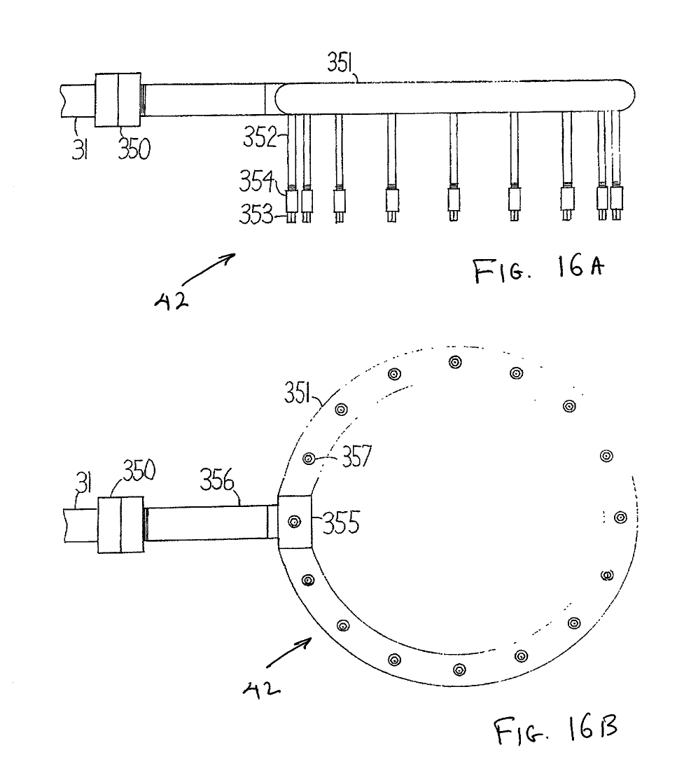

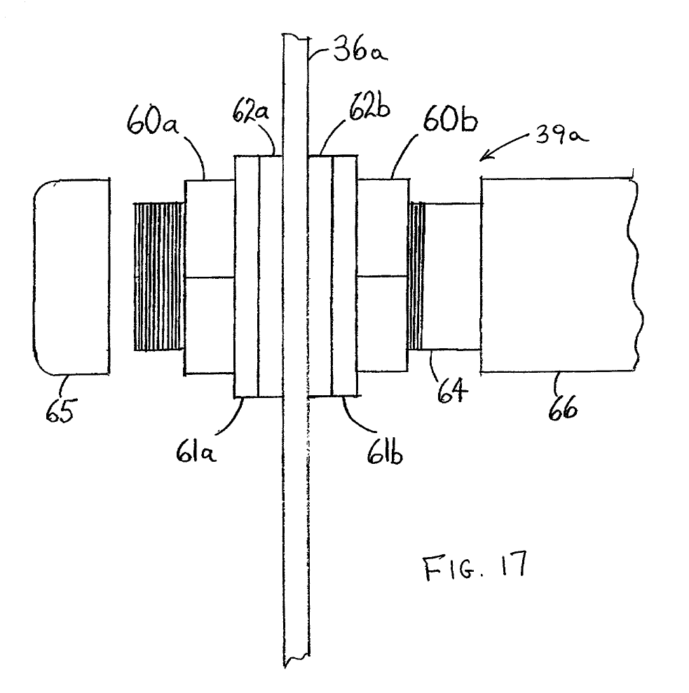

FIG. 7 depicts discharge pump hose connection 44. A threaded nipple 382 is inserted through a port (not shown) in the lower section of hopper holding tank 100. One end of threaded nipple 382 is attached to a threaded flange 384 mounted to discharge pump 22. Threaded nipple 382 is seam welded in the port (not shown) through hopper holding tank 100. Hose 21 is connected to the other end of threaded nipple 382 by a quick connect/disconnect coupling 383.

Referring now to FIG. 8 there is shown separator 24. Separator 24 is supported by adjustable separator support legs 25 welded at ninety degree intervals on a separator cylinder 192. Separator cylinder 192 contains a lower bearing support 183 welded inside separator cylinder 192, A lower shaft bearing 184 is attached to bearing support 183. A shaft slinger and screen wheel mounting plate 185 is welded to a screen wheel shaft 190. Screen wheel shaft 190 together with screen wheel mounting plate 185 bolted to a screen wheel 186 rests on lower shaft bearing 184. Above screen wheel 186 is located a gravel discharge port 187 in separator cylinder wall 192. Screen wheel 186 is rotated by a screen wheel drive wheel 188 attached to a screen wheel drive mechanism 29. An upper bearing support 194 bolted inside separator cylinder 192 holds an upper shaft bearing 195 and a rinse water supply pipe and spray manifold 191. Hatch 45 is located on separator cylinder 192 adjacent to gravel discharge port 187. A slurry discharge pipe 193 is inserted through a port (not shown) in the wall of separator cylinder 192. A quick connect/disconnect coupling 197 is attached to the threaded end of slurry discharge pipe 193. Slurry discharge hose 21 is connected to slurry discharge pipe 193 by coupling 197. Water is provided to rinse water supply pipe and spray manifold 191 installed through a port (not shown) in the wall of separator cylinder 192 by hose 31.

The details of screen wheel 186, mounting system and lower bearing support 183 and upper bearing support 194 are shown in FIG. 9. Lower bearing support 183 is centered and held in place by a lower bearing support rolled angle bottom centering shim 210a and a lower bearing support rolled angle top centering shim 210b which, after placed in position, are both welded to lower bearing support 183 and separator cylinder 192. A bearing mounting plate 214 is centered and welded on a lower bearing support hub (not shown) and welded to the lower bearing support spokes (not shown). Lower shaft bearing 184 is attached to bearing mounting plate 214 using four bolts and nuts 213. A screen wheel shaft 190 with shaft slinger and screen wheel mounting plate 185 welded in place is inserted into lower shaft bearing 184. Screen wheel mounting plate 218 (welded to screen wheel 186) is leveled inside separator cylinder 192 by four adjusting bolts 217 and held in place by four bolts and nuts 219 with shims 220. Screen wheel 186 is surfaced with a circular screen 223 with a rolled flat bar (not shown) welded to the inside and outside perimeter of the round screen. Circular screen 223 is attached to screen wheel 186 by a plurality of nuts and mounting studs 221 welded to the top side of the rolled channel (not shown) comprising the perimeter of screen wheel 186. A flexible gasket 228 is provided to seal between screen wheel 186 and separator cylinder 192. A conical screen 224 is placed at the center of screen wheel 186 also with a rolled flat bar (not shown) welded to the inside and outside perimeter of conical screen. Conical screen 224 is attached to round screen 223 by nuts and mounting studs 222 welded to the top of the inside perimeter rolled flat bar of round screen 223. Upper bearing support 194 is centered and held in place inside separator cylinder 192 by a plurality of shims 229 and bolts and nuts 231. A bearing mounting plate 230 is welded to a upper bearing support hub (not shown) and to the upper bearing support spokes (not shown). Upper shaft bearing 195 is attached to the bearing mounting plate by four bolts and nuts 233. Finally, a lifting eye 232 is welded to the top of screen wheel shaft 190.

FIG. 10 sets forth the details of separator support leg 25. A leg extension mount 258 is welded to the side of separator cylinder 192 opposite to the placement of lower bearing support 183 and lower bearing support rolled angle bottom centering shim 210a and lower bearing support rolled angle top centering shim 210b. A leg extension 253 with a vertical leg square tube 259 welded in place is inserted into leg extension mount 258. A top leg extension stabilizing shim 254 and a side leg extension stabilizing shim 255 are placed between the inside wall of leg extension mount 258 and the outside wall of leg extension 253. Leg extension 253 is held in leg extension mount 258 by a bolt 257 and a nut 256 welded to the top side of leg extension mount 258. A vertical leg 245 is inserted inside vertical leg square tube 259 (welded to the end of leg extension 253). Vertical leg 245 is held in place by an upper side leg stabilizing shim 251, an upper back leg stabilizing shim 252, a lower side leg stabilizing shim 249, and a lower back leg stabilizing shim 250. Hardened bolts 247 hold vertical leg 245, lower side leg stabilizing shim 249, lower back leg stabilizing shim 250 and vertical leg keeper 248 in place. A plurality of leg height adjusting holes 246 are provided to adjust separator 24 to the proper height. The vertical leg height is further adjusted by a lower leg adjustment plate 240 with four welded adjusting studs 241, an upper leg adjustment plate 244 welded to vertical leg 245 and held in place with three adjusting lock nuts 243a, 243b and 243c for each adjusting stud 241.

FIGS. 11A and 11B show the details of screen wheel 186, upper bearing support 194 and lower bearing support 183, three pieces that are similarly constructed. The perimeter of screen wheel 186, upper bearing support 194, and lower bearing support 183 is comprised of a rolled channel wheel 270 with flanges inside. A hub 272 is centered inside rolled channel wheel 270 and a plurality of flat bar spokes 271 are welded to rolled channel wheel 270 and hub 272. A mounting plate (plate 214 in the case of lower bearing support 183, plate 218 in the case of screen wheel 186 and plate 230 in the case of upper bearing support 194) is centered over hub 272 and welded to hub 272 and flat bar spokes 271. Four mounting holes 274 drilled in the mounting plates facilitate the attachment of upper shaft bearing 194, lower shaft bearing 184 and screen wheel shaft 190.

Screen wheel drive system 29 is shown in FIGS. 12A and 12B. A gear box 301 and an electric motor 302 are bolted to a screen wheel drive system mounting plate 308. Screen wheel drive wheel 188 is mounted on gear box 301. Screen wheel drive wheel 188 is rotated by gear box 301 and electric motor 302 at a speed to rotate screen wheel 186 at approximately sixty revolutions per minute. Screen wheel drive wheel 188 is positioned in a port on the side of separator cylinder 192 to contact screen wheel 186. Two mounting hinges 312 are welded to screen wheel drive system mounting plate 308 and separator cylinder 192. Screen wheel drive wheel 188 is held against screen wheel 186 by two mounting studs 304a and 304b welded to separator cylinder 192 and inserted through two holes (not shown) in screen wheel drive system mounting plate 308. A tensioning adjustment mechanism 313a around stud 304a consists, in sequence, of a steel washer 305a, a rubber washer 307a, a steel washer 314a, a tensioning spring 303, a steel washer 315a, a rubber washer 316a, a steel washer 317a and a lock nut 306a. A similar tensioning adjustment mechanism 313b is provided around stud 304b. Mechanisms 313a and 313b are used to adjust the engagement between screen wheel drive wheel 188 and screen wheel 186.

FIGS. 13A and 13B depict screen wheel drive system cover 30. A rolled cover 320 is of sufficient diameter to encompass screen wheel drive wheel 188 (not shown), gear box 301 (not shown), and electric motor 302 (not shown). A solid top cover 323 is welded to rolled cover 320. A bottom cover (not shown) is of perforated metal and welded to rolled cover 320. Two mounting hinges 322 are welded to rolled cover 320 and separator cylinder 192. A mounting tab 324 is welded to rolled cover 320. A mounting stud 321 is welded to separator cylinder 192 and inserted through a hole in mounting tab 324. A nut (not shown) holds rolled cover 320 closed.

Referring now to FIGS. 14A, 14B and 14C, there is shown gravel discharge chute 23 mounted over gravel discharge port 187 (not shown) by two gravel discharge chute mounting tabs 331 welded to gravel discharge chute 23. Two mounting studs (not shown) are welded to separator cylinder 192. gravel discharge chute 23 is held in place by two lock nuts (not shown) threaded on the mounting studs.

FIGS. 15A and 15B show the details of hatch 45. Hatch 45 consists of a curved door section 340 cut out of separator cylinder 192 with curved flat bar sections 344a and 344b and straight flat bar sections 345 and 346 overlapped and welded to curved door section 340. Hinges 343 are welded to flat bar section 345 and to the separator cylinder (not shown). Mounting slots 342 are cut into flat bar section 346. Studs (not shown) are welded to the separator wall (not shown) to fit through the mounting slots to hold the separator access door closed by a nut and washer (not shown). A rubber gasket 341 is affixed to the back sides of curved flat bar sections 344a and 344b and straight flat bar sections 345 and 346.

FIGS. 16A and 16B set forth the details of rinse water supply pipe & spray manifold 42. A spray pipe manifold 351 is rolled into a circle with a weld tee 355 welded at each end of spray pipe manifold 351. A weld nipple 356 (threaded on one end) is welded to weld tee 355. Separator water supply hose 31 is connected to weld nipple 356 by a quick connect/disconnect coupling 350. A plurality of holes (not shown) are drilled on the underside of spray pipe manifold 351 and a nipple threaded on one end 352 is inserted and welded in each hole. A threaded coupling 354 is attached to each nipple 352. A fan spray jet 353 is then installed in each threaded coupling 354. Nipple 352, threaded coupling 354, and fan spray jet 353 comprise spray assembly 357.

Referring now back to FIGS. 1A and 1B, sand holding tank 26 and water holding tanks 36a, 36b, 36c and 36d are waste industry standard roll on/roll off containers, each equipped with a water tight door. As stated previously, tank 36a overflows to tank 36b, tank 36b overflows to tank 36c and tank 36a overflows to tank 36b via pipes 39a, 39b and 39c, respectively.,

Referring now to FIG. 17, there are shown details of one of the three pipes 39a enabling water tank to overflow into tank 36b. Pipe 39a is located below the top of water tank 36a to allow for freeboard. A threaded nipple 64 (threaded one end only) is inserted in a port (not shown) cut in the wall of water tank 36a. The port is sealed by pipe nuts 60a and 60b, steel washers 61a and 61b and rubber washers 62a and 62b installed on threaded nipple 64 on both sides of the wall of water tank 36a. A threaded cap 65 is supplied as part of pipe 39a to provide for tank drainage. Similar assemblies are applicable for the remaining pipes that provide the overflow from one water tank to another, as previously described.

FIG. 18 shows the details of water tank discharge assembly 37a. A threaded tee 73 is fitted with a threaded nipple 72a connected to a quick connect/disconnect coupling 71a, another threaded nipple 72b connected to a quick connect/disconnect coupling 71b, and a threaded nipple 72c connected to valve 75. Valve 75 is fitted to a threaded nipple 76 inserted through a port (not shown) at the bottom of water tank 36a. This port is sealed by pipe nuts 77a and 77b, steel washers 78a and 78b, and rubber washers 79a and 79b installed on threaded nipple 76 on both sides of the wall of water tank 36a. Assemblies 37b and 37c are constructed similarly.

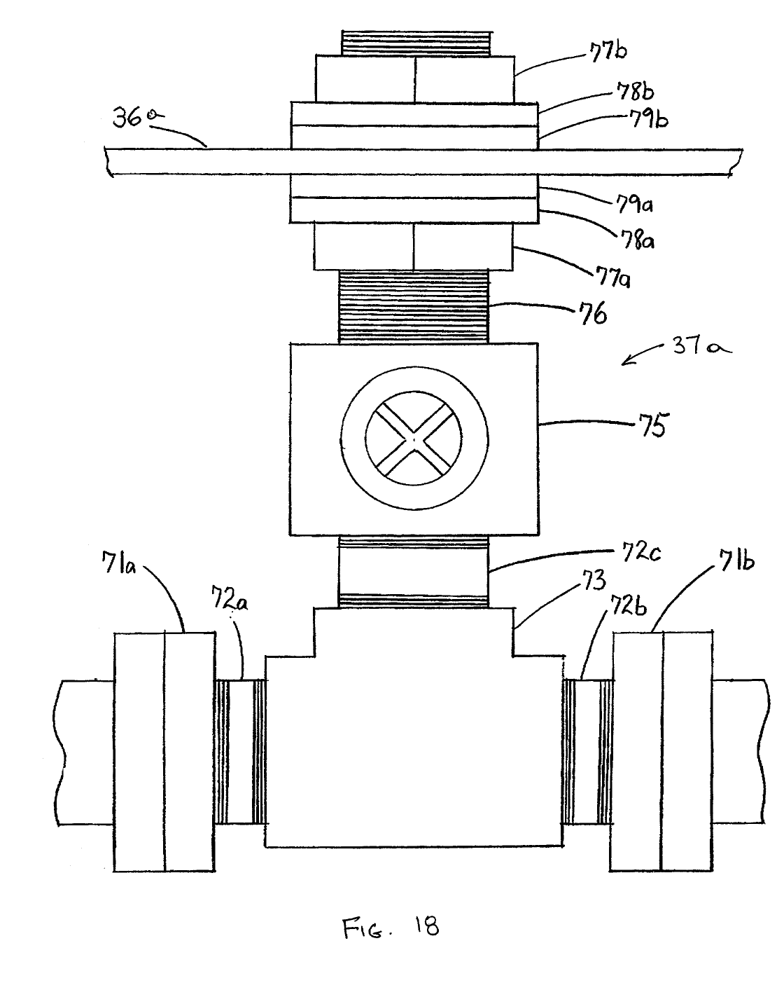

FIGS. 19A and 19B show the details of water distribution manifold 33 connected to water supply pump 34 by a threaded nipple 52j, a threaded ninety degree elbow 51a and a threaded nipple 52a. Separator water supply hose 31 is attached to a threaded ninety degree elbow 51b by a quick connect/disconnect coupling 55c, a threaded nipple 52i, a valve 54c, and a threaded nipple 52h. A utility hose 39 is attached to a threaded tee 53b by a quick connect/disconnect coupling 55b, a threaded nipple 52f, a valve 54b, and a threaded nipple 52e. Discharge hopper water supply hose 27 is connected to a threaded tee 53a by a quick connect/disconnect coupling 55a, a threaded nipple 52c, a valve 54a, and a threaded nipple 52b. Threaded ninety degree elbow 51b, threaded tee 53b, and threaded tee 53a are connected together using threaded nipples 52d and 52g.

Referring now back to FIGS. 1A and 1B and FIG. 2A, 2B and 2C, in operation, a concrete mixer truck (not shown) carrying unused, uncured concrete positions its discharge chute over hopper 20. Prior to discharging the concrete into hopper 20, the system is turned on to activate the pumps and to begin the rotation of screen wheel 186. Pump 34 is activated to begin pumping water to hopper 20 and separator 24 via hoses 27 and 31, respectively. The water flows into hopper 20 through the nozzles previously described in detail into the upper portion of hopper 20 to create a water swirling action and into the lower portion of hopper 20 to further break up and dilute the uncured concrete and to cool discharge pump 22. The concrete from the truck as well as any washed material from the truck concrete container is then discharged into hopper 20 where is it contacted by the water to create a diluted concrete slurry which is pumped by pump 22 to the upper portion of separator 24 through line 21. Therein, the water is sprayed through sprayers described above with water being provided by hose 31. The slurry flows by gravity inside separator 24. When the slurry reaches rotating screen wheel 186 which has a circular screen 223 and conical screen 224 thereon, rock material larger than ¼ inches is screened out from the slurry and is centrifugally directed to port 187 for discharge from separator 24 through chute 23. The remaining material comprising cement, sand and water slurry flows by gravity to the bottom of separator 24 and exits therefrom through its open end to fall by gravity to sand tank 26 where most of the sand settles. The effluent from tank 26 flows via pipes 28 to water holding tank 36a. Overflow from tank 36a flows to tank 36b through pipes 39a. Overflow from tank 36b flows to tank 36c through pipes 39b. Overflow from tank 36c flows to tank 36d through pipes 39c. Water is continuously removed from the bottom of tanks 36a, 36b, 36c and 36d via discharge assemblies 37a, 37b, 37c and 38, respectively, to hose 35 which is connected to pump 34. Pump 34 discharges the water to manifold 33 which is connected to hoses 27 and 31 and a utility hose (not shown). The utility hose can be used to provide water for washing the truck concrete container, draining the water tanks and to perform any other utility tasks customary in the industry. In the process described, the rock is separated from the concrete slurry in separator 24, the sand is separated from the water/cement slurry in tank 26 and cement light material is separated from the water in tanks 36a, 36b, 36c and 36d. The separated rock, sand and light cement material are thus recovered for future use.

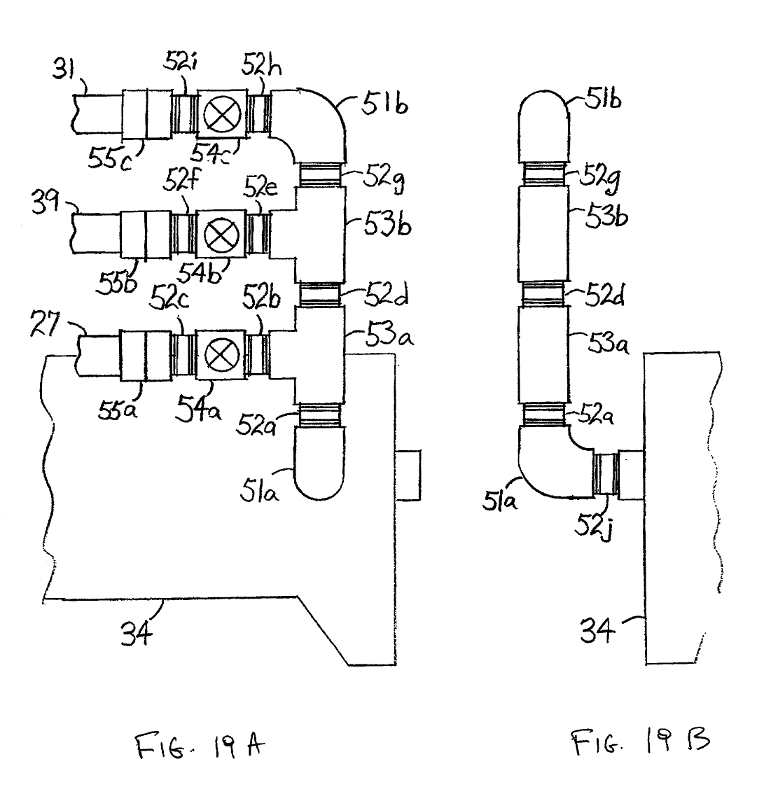

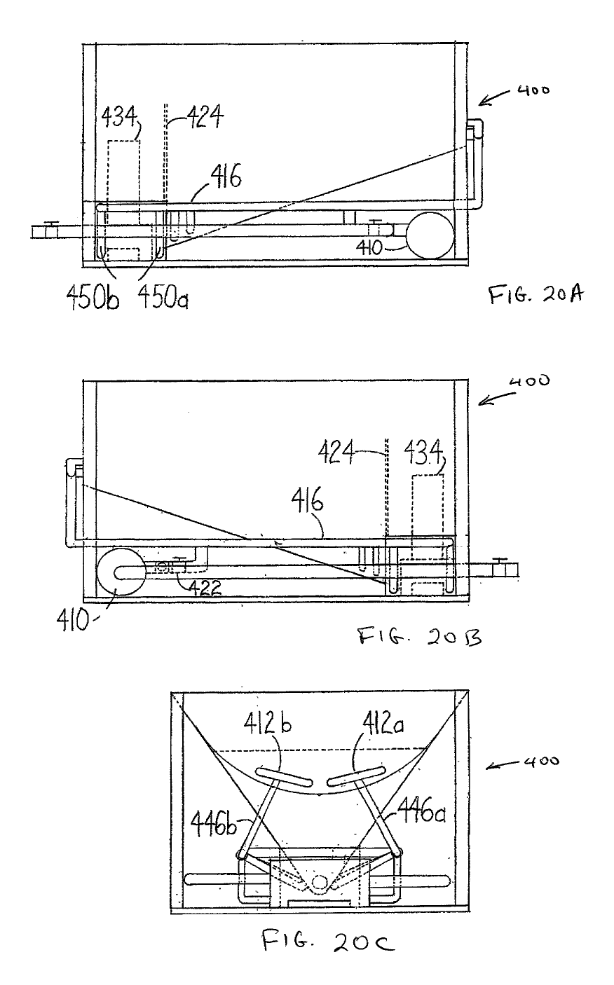

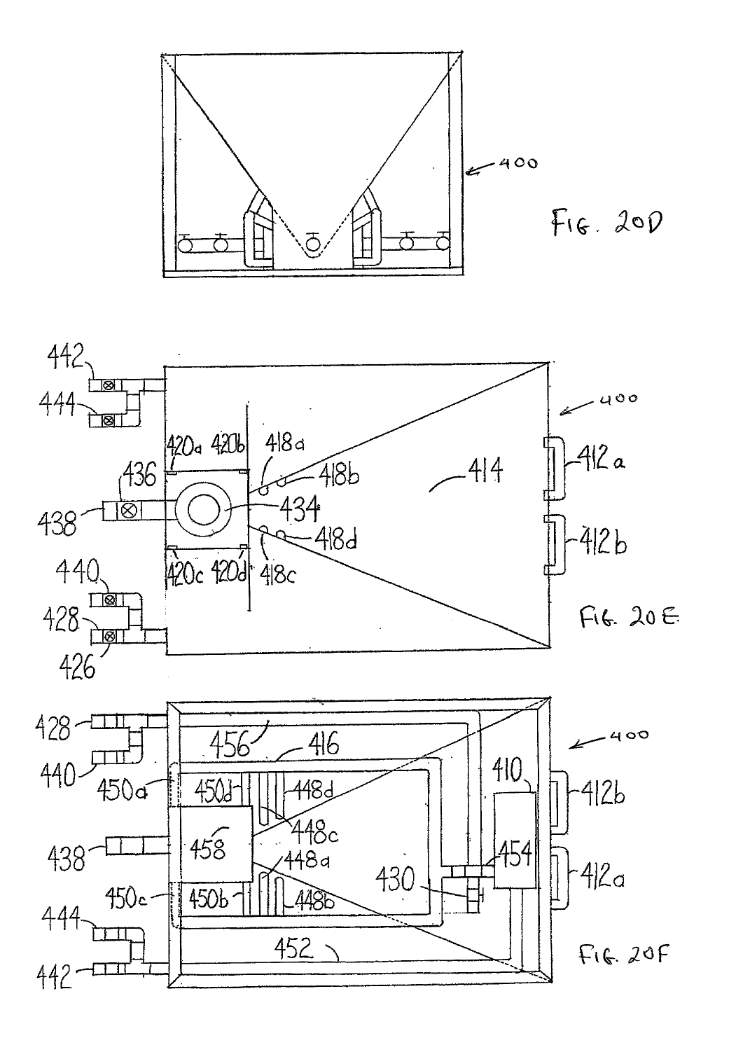

Hopper 20 and pump 34 are preferably used in connection with concrete reclaimer 10 when the material being handled is one inch sieve size or less. In the event the material being handled is larger, it is preferred that hopper 20 and pump 34 of concrete reclaimer 10 be replaced with a hopper 400 suitable for handling large and dense material such as river rock that will pass though a sieve size up to 1.5 inches. Referring now to FIGS. 20A, 20B, 20C, 20D, 20E and 20F, there is sown hopper 400 having a discharge chute 414, shaped as ⅓ of a cone welded in a sloped disposition with the wide end elevated and the narrow end welded into the opening in a sump 458. The upper edge of discharge chute 414 is at a height suitable for receiving discharge of waste, uncured concrete from a concrete mixer truck.

Slurry water flows to water supply pump 410 via a water tank drain hose connection with on/off valve 442 or a sand container drain hose connection with on/off valve 444 and the water supply pump fill pipe 452 Hose 442 is only used to drain excess water from the sand container before removing sand.

The slurry water is discharged from water supply pump 410 via a water supply pump discharge connection 454. The slurry water flows through water supply pump discharge connection 454 into a utility hose connection 432 equipped with a utility hose valve 430, a separator/batch plant water supply pipe 456, and a discharge chute and sump water supply manifold 416.

The slurry water flowing through separator/batch plant water supply pipe 456 is supplied to separator 24 (shown in FIG. 1A) via the separator water supply hose connection. The flow of the slurry water to separator 24 is regulated via a separator water supply metering valve 426. Alternatively, the slurry water flowing through separator/batch plant water supply pipe 456 is supplied for general batch plant use via a batch plant water supply hose connection with on/off valve 440.

The slurry water flowing through the discharge chute and sump water supply manifold is supplied to discharge chute upper water nozzles 412a and 412b, discharge chute lower water nozzles 418a, 418b, 418c and 418d, and sump water nozzles 420a, 420b, 420c and 420d via the water supply line to discharge chute upper water nozzles 446a and 446b, water supply line to discharge chute lower water nozzles 448a, 448b, 448c and 448d, and water supply line to sump water nozzles 450a, 450b, 450c and 450d. The slurry water flowing through the discharge chute and sump water supply manifold is metered using a hoper water supply metering valve 422.

The slurry water and the uncured concrete introduced into the discharge chute 414 flows down the chute to a slurry metering baffle 424. At the bottom of the slurry metering baffle 424 where it is welded to the lower end of the discharge chute 414 is a hole having the same size diameter as the suction end of slurry discharge pump 434. This hole regulates the flow of uncured concrete mixed with slurry water into the sump 458 so as not to overcome the pumping capacity of slurry discharge pump 434. Slurry discharge pump 434 pumps the concrete slurry mixture to separator 24 via slurry discharge line valve 436 and slurry discharge line hose connection 438.

The system described herein is lightweight and portable whereby it can be easily transported in places where its use is the most efficient and economical. All of its components are above ground whereby it does not require digging pits or the like.

While preferred embodiments of the invention have been shown and described, modifications thereof can be made by one skilled in the art without departing from the spirit of the invention.

What is claimed is:

1. An apparatus for reclaiming concrete, comprising:
a hopper with water means for introducing water to the hopper;
a separator having an inlet for receiving material from the hopper;
a screen positioned in the separator;
a first outlet for removing material from the separator; and
a second outlet for removing material from the separator.
